(19) United States
(12) Patent Application Publication
(10) Pub. No.: US 2012/0286509 A1
(43) Pub. Date: Nov. 15, 2012

(54) METHOD FOR OPERATING A WIND TURBINE AND WIND TURBINE SUITED THEREFOR

(76) Inventor: Axel Rafoth, Rostock (DE)

(21) Appl. No.: 13/386,215

(22) PCT Filed: Jul. 23, 2010
(86) PCT No.: PCT/EP10/60759

§ 371 Date: Jul. 30, 2012

(30) Foreign Application Priority Data
Jul. 23, 2009 (DE) 10-2009-027.981.4

(51) Int. Cl. H02P 9/04

(52) U.S. Cl. 290/44

(57) ABSTRACT

In a wind turbine, when a deviation of a grid voltage from a certain regular grid voltage range occurs, current residual grid voltage is measured, current wind speed is measured, a certain time period starting with the detecting of the change in grid voltage is defined depending on the value of the residual grid voltage, and the wind turbine is operated within the defined time period depending on the value of the residual grid voltage in a certain operating mode that deviates from regular operation with respect to the effective power, and the wind turbine is operated again in the regular operating mode after the grid voltage has normalized again within the defined time period, or is shut off at the end of the time period if the deviation of the grid voltage persists.

### FIELD OF THE INVENTION

The present invention relates to a method for operating a wind turbine connected to a power grid for the electric energy generation when a change in a grid voltage occurs, and a wind turbine for implementing the method according to the present invention.

### BACKGROUND OF THE INVENTION

Wind turbines are commonly connected to the public power supply grid for the supply of the electric energy. In this power supply grid, voltage error or voltage deviation, for example, short circuit can occur, which results in a temporary decrease or also increase of the voltage in one or more phases. Conventional wind turbines will separate their connection to the grid after they recognize such a grid error and shut themselves off automatically. Such a shut off process of conventional wind turbines is described in FIG. 1, in which signal states of a grid error 1.1, an error notification 1.2 and a trigger operation 1.3 are described over the time. Herein, the signal states can only have the state of 0 or 1. When a grid error 1.1 occurs, a signal related to this grid error will be generated for the duration of the reaction time 1.4. The signal for the error notification 1.2 will be triggered with the beginning of the signal about the existence of a grid error 1.1. In turn, the end of the signal about the error notification triggers the trigger operation 1.3, which in turn causes the shut off of the wind turbine. It is apparent that a relative long shut off delay 1.5 from the obtaining of the grid error 1.1 to the actual shut off of the wind turbine occurs.

According to legal regulations of the different countries or regions, there exists the requirement for the wind turbines to maintain the energy production properly when an error of the power supply grid occurs. Especially for the situation in which the number of the wind turbines in the power supply grid increases, it is consequently required to modify the operation action of the wind turbines so that the arrangements ride through grid error and then support the reconstruction of the grid. For this purpose, different countries or regions have defined voltage limits, wherein the wind turbines may not be shut off until the voltage limits is undershoot. That is, when a deviation of a grid voltage or a grid error occurs in a range, which is above the defined voltage limit, the wind turbine should be still connected with the grid. Under the condition of certain voltage drop values, the arrangement should ride through the error or the state of the deviation of a grid voltage. This ride through is also described as “Low Voltage Ride Through” (LVRT). Herein, by means of characteristic lines depending on the current voltage value that deviates from the regular voltage range, it is given, how long the time period should be for further operating the wind turbine and/or in which operation state the wind turbine should be further operated. In the case of the grid voltage dip, the energy flow between wind turbines and grid changes itself, under certain conditions, less or no energy can be delivered to the power grid. The operation when riding through a variation of the grid voltage will be described as LVRT-operation in the following.

When normalizing grid voltage within the given time span, the wind turbine should also be in the regular operation again. However, if the deviation of the grid voltage or the grid error exists over the duration of the given time span, the wind turbine may be separated from the grid or be shut off.

Such kind of characteristic line for adjusting the dwell time in the grid depending on the respective voltage is described in FIG. 2. Herein, it is apparent that, for example, when a voltage drops to the voltage U1, it is given through the characteristic line 2.1, that the time t1 will be ridden through in LVRT-operation and the wind turbine will not be shut off until the time t1 is expired, if no grid voltage normalization should have been adjusted until then. When a voltage drops to the value U2, the wind turbine is shut off at the time of t2. It is apparent that, the higher the remaining residual voltage in the grid is, the longer the dwell time in the grid for the wind turbine is.

In one aspect, the operation of the wind turbine in the LVRT-operation is used to avoid the possible load states and error states of the turbine, which could be generated through the respective voltage dip. In another aspect, the operation of the wind turbine will be at least partly properly maintained, so as to prevent a complete collapse of the grid consequently and enable a rapid grid reconstruction.

### SUMMARY OF THE INVENTION

Thus, the task of the present invention is to provided a method and a wind turbine to implement the method, with which the operation of the wind turbine can be maintained properly in a simple, time-and cost saving way when a deviation of the grid voltage occurs, and especially under the condition of keeping the given power drain and the given time frame, a complete collapse of the grid can be prevented and a rapid grid reconstruction can be guaranteed.

In order to solve the task, it is provided a method for operating a wind turbine connected to a power grid for the electric energy generation when a change in a grid voltage occurs, wherein the current residual grid voltage will be measured when a deviation of a grid voltage from a certain regular grid voltage range occurs, the current wind speed will be measured, a certain time period starting with the detection of the change in the grid voltage will be defined depending on the value of the residual grid voltage, and the wind turbine will be operated within the defined time period depending on the value of the residual grid voltage with a certain operation mode that deviates from the regular operation and the wind turbine will be operated again in the regular operation mode after the grid voltage has been normalized within the defined time period, or the wind turbine will be shut off at the end of the time period if the deviation of the grid voltage persists during the defined time period.

According to the present invention, it is set, that voltage ranges are defined for grid voltage values that are not included in the regular grid voltage range, wherein a plurality of voltage values and at least one first factor for controlling the wind turbine, which is optionally different for each voltage range, are attributed to each defined voltage range so as to realize the operation mode deviating from the regular operation mode, and depending on the measured wind speed, one of the first factors for controlling the wind turbine is used to realize the deviating operation mode.

The regular grid voltage range has a voltage lower limit, which usually will be undershoot when a voltage dips. Such a deviation of a grid voltage or a undershooting of the voltage limit should cause the adjustment of the changed operation. Thus, the deviation of a grid voltage can be understood as a voltage dip, that is, an error of the power supply grid, such as short circuit, for example, which will cause a temporary increase or decrease of the voltage in one or more phases.

The regular operation or the normalization of the grid voltage can be understood as the operation of the wind turbine, when no deviation of the grid voltage from the limit grid voltage range occurs. When measuring or recognizing a deviation from the regular grid voltage range, the wind turbine should be operated in a special operation mode, especially with reduced power, within a defined time period. If the deviation of the voltage exceeds the defined time period with regard to time, the wind turbine should be shut off. If the gird voltage is normalized again within the defined time span, the wind turbine should also further work again in the regular operation since this time point. Namely, when it is recognized or measured, that the grid deviation is ended, the wind turbine will be switched back to the mode of the regular operation again. This means, that there is a time span of the transition between the deviating operation mode and the regular operation since the switch to regular operation, in which all the adjustment to realize the regular operation are already essentially accomplished.

The method is used for the purpose that one and especially more wind turbines operated according to the present invention can ride through the grid error in LVRT operation when the grid error occurs. Wherein the wind turbines support the reconstruction of the grid through their latent complete readiness for operation and/or through their latent, even if reduced power drain, in the event that the grid error has been eliminated within a certain time period that is previously decided according to the effective determination. This mode for riding through the grid error will also named as LVRT-mode (Low Voltage Rid Through), wherein the wind turbine remains connected with the grid. If the grid error has not been eliminated within this time period, the wind turbine will be separated from the grid and shut off.

When a gird error occurs, a plurality of influencing variables influence the wind turbine, which should be further operated in a fully determined, given LVRT-operation that depends on the voltage drop. This influencing variable, for example, are the remaining residual grid voltage, the prescribed dwell time, which is derived from the remaining residual grid voltage, of the wind turbine in the grid and the dominant wind regime.

The almost continuous calculation of the suitable adjustment variables to realize the power reduced operation would either demand a relatively long time, during which the wind turbine does not correspond to the required operation conditions, or it requires a relatively high computation or control capacity.

In the context of the invention it is disclosed that factors for the adjustment of the wind turbine are attributed to current ranges which are deviated from the regular voltage range. Through using each of the first factors as control parameter respectively, the reaction to a voltage dip will be much more rapid, since only the factor, which is attributed to the voltage range, where the residual grid voltage is located, will be called, and used to control the wind turbine depending on, for example, the offsetting, wind speed.

Herein, it can be set, that the defined voltage ranges are overlaid with each other or abut against each other. Advantageously, they should be abut against each other, since additional suitable criteria for the selection of the respective range, and thus the effective factor in the overlapped range should be raised in the situation of the overlap of the defined voltage ranges.

Furthermore, it is set, that wind speed ranges will be defined, wherein a plurality of wind speeds are attributed to each defined wind speed range, and at least one second factor for controlling the wind turbine for each wind speed range will be attributed to each wind speed range, so as to realize the operation that deviates from the regular operation. Especially preferably, the second factor influences the power of the wind turbine.

Thus, an advantage is obtained, that the factors for the adjustment of the wind turbine are attributed to the wind speed ranges, and the reaction to the voltage dip will be much more rapid, since only the factor, which is attributed to the wind speed range, where the current wind speed or the turbine working point is located, will be called and used to control the wind turbine.

In order to further simplify and accelerate the determination of the adjustment value to realize the desired power, it is set that a control desired value for the operation of the wind turbine is generated from the combination of the first and second factors so as to adjust the operation mode that deviates from the regular operation. Herein, the first factor can be combined with the second factor, for example, computationally.

In order to influence the aerodynamic power of the wind turbine in a goal-oriented manner, it is set that the first and/or the second factor and/or the control desired value can used to influence the blade angle of the rotor blade of the wind turbine.

Through changing the blade angle—also named as pitch angel—of the rotor blade, the absorbed aerodynamic power, and thus the number of the rotor revolution also will be influenced in a simple way. Therefore, an overwinding of the wind turbine can be avoided when a voltage dip occurs. By the adjustment of the blade angel, the angel of attack of the wind turbine will be set so, that the blades will no longer be optimally blew and the rotor revolves slowly and/or the rotor moment is reduced, whereby the desired LVRT operation mode can be realized. From this operation mode, the wind turbine can be either restored very rapidly again to the regular operation mode or shut off.

When a voltage dip occurs, an aerodynamic rotor brake arrangement of the wind turbine will also no longer be supplied with enough electric energy, so that the wind turbine can no longer be braked if necessary. Herein, the adjustment of the blade angles enables battery operation under certain conditions, that is, it does not require grid voltage to adjust the blade angles, so that the blade angle can also be adjusted in an autarkic manner when a severe grid dip occurs.

In an especially preferable embodiment, the first factor can cause or be a control signal for a revolution number regulator, wherein the revolution number regulator cause the change of the blade angle. In other words, this means, that when a certain limit voltage is undershoot, the wind turbine will be operated in LVRT-operation and thus the certain values of the revolution number will be adjusted through the change of the blade angle. The increased load, for example, overwinding of the arrangement, will be avoided by the desired values of the revolution number that is given according to the operation mode and wind speed, and meanwhile the wind turbine will be maintained in operation, so as to be available during the grid reconstruction more rapidly and so as to avoid that the grid will not collapse during the grid error.

Advantageously, it is set, that the value of the current blade angle when a change in the grid voltage occurs will be obtained or called, and an offset angle value will be determined from the first and/or the second factor and/or the control desired value, or such an offset angle value, which is previously stored in a memory for a respective voltage range not included in the regular grid voltage range, will be called from the memory, and will be fed to a controller of the wind turbine for the purpose of intrusion on the current blade angle, and the blade angle will be correspondingly changed. Therefore, the blade angle adjustment is accomplished by taking account of the current blade angles when the deviation of the grid voltage occurs. Herein, the offset angle value can also be computationally determined.

Alternatively or additionally, it can be set, that a first factor and/or a control desired value are used to regulate the operation of a resistance unit. Such a resistance unit can be resistances of a rotor of an asynchronous generator with cage rotors or can also be a resistance in a direct current voltage intermediate circuit of a rotor of an double fed asynchronous generator. Herein, a resistance unit can include a switch, especially an IGBT-switch, and at least one or more resistance that current can go through. Therefore, the influence of the operation of the generator and/or under certain conditions a transformation from the generated electric energy to heat energy can be realized. This means, that a first factor can also be used to control the so-called duty circle. This means that the switch period and/or—frequency of the switch mentioned above, especially the IGBT-switch, and consequently the trigger of the resistance unit can be influenced.

Alternatively, it is possible, that the combination of the first factor with the second factor leads to a third factor, which is used to regulate the IGBT-switch and thus the resistance. At least one of the factors and/or the control desired value should be used to adjust the cable electronic system of the wind turbine. If necessary, the combination of the first factor with the second factor is a computational combination.

Therefore, the adjustment of the cable electronic system of the wind turbine can be realized to influence the operation mode of the wind turbine, because in this way the adjustment of the blade angle and/or the energization of the resistance unit can be conducted. Thus, unacceptable load state and/or error states for these systems caused by the voltage dip and/or possible voltage normalization are avoided.

To guarantee that the deviating operation mode will be carried out at least for a prescribed time period when a deviation of a gird voltage occurs, it is set, that the defined time period will be defined according to the highest voltage value of a defined grid voltage range.

As mentioned, a time window will be defined according to a given characteristic lines, within which the wind turbine can be operated in a LVRT-operation. Herein, according to the present invention, the time period will be defined according to the greatest voltage value for each selected range.

Since the characteristic line has a positive slope, the defined time period is at least just as long as the time period given through the characteristic line for the deviating operation.

In the context of the LVRT-operation of the wind turbine, alternatively or additionally to the measures mentioned above, a special trigger of apparatuses can be carried out, which does not influence the performance of the wind turbine directly, such as, for example, oil pump, fan, driving motor for the yaw system, namely all auxiliary motors, which will not be directly needed for the regulation of the revolution number of the rotor or resistance energization. Especially, these apparatus are shut off in the course of LVRT. This is essentially used for the operation assurance of the apparatuses for the time after the deviation of the grid, so as to protect the electrical system of the wind turbine from an undefined current impulse. Therefore, it can be additionally set, that through at least one of the factors and/or through the control desired variable, a time that is taken for influencing the operation manner of the wind turbine is longer than the determined time period or the time during which the deviation of the grid voltage occurs.

In order to maintain the grid in the case of a simultaneous option of shutting off the wind turbine rapidly, it is set, that the method is so developed, that the wind turbine generates less power in the operation mode deviating from the regular operation regarding the power than in the regular operation.

In order to minimize the calculation cost and thus the necessary time to implement the method, the method can be so implemented, that a respective first and/or second factor and/or control desired value attributed to the respective voltage range and/or wind range is defined and stored in at least one memory and is called therefrom for the adjustment when the deviation of the voltage corresponding to the respective factor and/or control desired value occurs. It means that tables are stored in the memory, and in these tables, the factors attributed to the ranges of at least one of the reference values voltage and wind speed are stored. Therefore, the factors and/or control desired value will be defined and stored before a deviation of a grid voltage occurs, so that when, for example, a grid error occurs, they can be used to control the wind turbine, especially to adjust the blade angle and/or the operation of the resistance unit.

Additionally, according to the invention, it is set, that at least one of the factors and/or the control desired value is used for the selection and trigger of wind turbine apparatuses, which are shut off during the time of the deviation of the grid or also operated in an operation mode which deviates from its regular operation mode. This means, that the existence or the amount of a factor or the control desired value determines which apparatus will be shut off during the grid error. Usually, they are those apparatuses, whose operation has no direct influence on the performance. Such kinds of apparatuses are, for example, oil pumps, fans and driving motors for the adjustment of the yaw system.

Additionally it can be set, that at least one of the factors and/or the control desired value is used to control the idle power during the deviation of the grid. Herein, the idle power can be adjusted by means of a compensation arrangement. Such a compensation arrangement can be a capacitor control box for the compensation of the idle power.

For the adjustment of the operation performance of the wind turbine after the end of the deviation of the grid, it can be set in the transition back to the regular operation, that at least one of the factors and/or the control desired value is used for the adjustment of parameters of the operation after the end of the deviation of the grid.

Herein, the produced parameter can exist as function, for example, that allows how soon it could be start again after the end of the error. Herein, according to the depth of the voltage dip and the time of the deviating operation mode, different start-up performance can be required.

Additionally, the method according to the present invention can be so developed, that at least one of the factors and/or the control desired value is used for the generation of parameters so as to adjust error suppression time. The error suppression time is used for the adjustment of the reaction delay of certain apparatuses of the wind turbine energized by the grid, thus that apparatuses will be switched on and/or shut off in a desired or required sequence.

Preferably, the method is so developed, that at least one of the factors and/or the control desired value is used for the generation of a maximal number of the repetition of the deviation of the grid within a second defined time span, wherein the wind turbine will be shut off when the maximal number has been exceeded. Moreover, the second defined time span is previously decided for each voltage range and for each wind strength if necessary.

The range of the deviation of the grid voltage can be divided to a first voltage range with greater than 90% of the regular grid voltage, to a second voltage range with 90-45% of the regular grid voltage, to a third voltage range with 44-22% of the regular grid voltage and to a fourth voltage range with 21-0% of the regular grid voltage. The first voltage range will be preferably interpreted as regular voltage range, in which the wind turbine will not be operated in the LVRT-mode.

Herein, it is set, that the certain time period of the realization of the deviating operation mode, beginning with the detection of the change in the grid voltage, is 0 second long in the first voltage range, and 2.5 seconds long in the second until the fourth voltage range respectively.

In the case of deviation from the required time period, which is 2,5 or 2,3 s in the second voltage range, 1,75 s in the third voltage range and 1,12 s in the fourth voltage range, the adjusted time of the deviating operation mode exceeds the required time in the third and fourth voltage range consequently, which although causes an extended operation period of the wind turbine, in another aspect allows an essentially simpler and thus rapider computation of the control parameter of the wind turbine.

The wind speed is divided to a first wind range with 4-7, a second wind range with 8-11, a third wind range with 12-14 and a fourth wind range with greater than 14 m/s.

In the case of the further deviation of the grid voltage, the method can be so implemented, that when a new change of the grid voltage occurs within the defined time period at a voltage value, which is not included in the voltage range corresponding to the initial deviation of the voltage, another first factor for controlling the wind turbine will be used to realize the operation mode which deviates from the regular operation mode.

This means, that in the case of the further voltage drop, another first factor will be generated or called other than the factor adjusted according to original voltage drop.

The similar situation is related to the control desired variable and the second factor if necessary, in the case of the correspondingly long measured time period for the operation in the deviating operation mode (LVRT), in which a repeated wind speed measure is meaningful.

In order to solve the task, additionally, a wind turbine, which is connectable or connected to a power grid to supply electric current, will be provided. The wind turbine according to the present invention include the following devices: at least one gird voltage measuring device, at least one wind speed measuring device, which can be also external positioned if necessary, at least one control device, set to realize a plurality of operation modes which deviate from the regular operation, and at least one first memory, in which first factors attributed to different grid voltage ranges are storable or stored. The wind turbine according to the present invention is especially developed for the implementation of the method according to the present invention.

Herein, it can be set, that the wind turbine additionally includes a second memory, wherein the second factors attributed to different wind speed ranges can be stored or are stored in the respective first and/or second memory.

In order to store the control desired value generated from the computational combination of the first or second factor, it can be set, that the wind turbine includes a third memory or that the first and/or second memory of the wind turbine is so developed, that the control desired values are storable or stored in them.

Alternatively or additionally, it can be set, that the wind turbine includes at least one computation unit, by means of which an offset-angle value can be calculated from the first and/or the second factor and/or the control desired value.

For the regulation of the effective power, the wind turbine includes at least one resistance unit, by means of which the operation performance of the wind turbine, especially of the generator can be influenced, wherein the electric energy generated from the wind turbine can be transformed to heat energy possibly for the purpose of the regulation of the effective power of the wind turbine. Additionally, the wind turbine can include at least one compensation arrangement, by means of which the idle power of the wind turbine can be adjusted.

Additionally, according to the present invention, a computer program is provided, that after it is loaded in a memory means of a data processing device, it enables the data processing device to implement the method for operating a wind turbine connected to a power grid for the electric energy generation when a change in a grid voltage occurs according to the present invention.

This means, the computer program enables at least the following steps or gives the corresponding control instructions: measuring the current residual grid voltage when the grid voltage deviates from a certain regular grid voltage range, measuring the current wind speed, defining a certain time period beginning with the detection of the change in the grid voltage depending on the value of the residual grid voltage, operating the wind turbine within the defined time period depending on the value of the residual grid voltage in a certain operation mode deviating from the regular operation regarding the effective power, operating the wind turbine again in the regular operation mode after the grid voltage has been normalized with the defined time period, or shutting off the wind turbine at the end of the time period if the deviation of the grid voltage persists during the defined time period, providing first factors for controlling the wind turbine, which are different for each voltage range, to realize the operation mode that deviates from the regular operation mode.

The invention relates to a computer readable memory medium, on which a program is stored, after the program is loaded in a memory means of a data processing device, it enables the data processing device to implement the method for operating a wind turbine connected to a power grid for the electric energy generation when a change in a grid voltage occurs according to the present invention.

Therefore, the invention also includes a method, wherein the computer program according to the present invention is downloaded from an electrical data network, for example, from the internet, to a data processing device connected to the data network.

The invention is also related to a method for controlling a wind turbine in the case of grid errors by means of tables. The grid errors will be classified according to regulations. This classification is suitable for predefined tables with operation parameters of the wind turbine. Some parameter can have availability, which is longer than the duration of the grid error. This is based on the step formation along the characteristic line.

### BRIEF DESCRIPTION OF DRAWINGS

The present invention will be described by means of the appended figures. In the drawing:

FIG. 1 shows of a shut off performance of a conventional wind turbine,

FIG. 2 shows a given characteristic line,

FIG. 3 shows a given characteristic line with the step formation according to the invention,

FIG. 4 shows a signal state in the case of the operation of a wind turbine when the deviation of the grid voltage and the normalization of the grid voltage within the time period defined by the characteristic line occur,

FIG. 5 shows signal states in the case of the operation of a wind turbine when the deviation of the grid voltage and the normalization of the grid voltage accomplished after the time period defined by the characteristic line occur,

FIG. 6 shows a wind turbine according to the invention in a schematic description according to a first embodiment, and

FIG. 7 shows a wind turbine according to the invention in a schematic description according to a second embodiment.

### DETAILED DESCRIPTION OF EMBODIMENTS

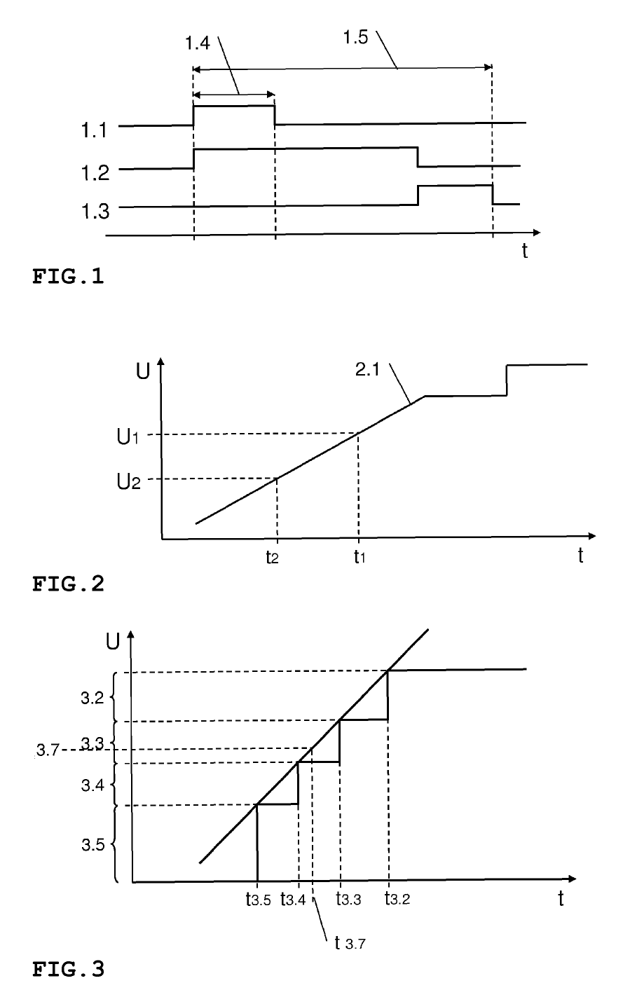

In the FIGS. 1 and 2, the description of the prior art has already been described.

In FIG. 3, the adjusted characteristic line 3.1 essentially corresponds to the characteristic line 2.1 shown in FIG. 2. As shown in FIG. 3, the voltage axis is divided to ranges 3.2 to 3.5, wherein time t3.2 to t3.5 are attributed to the ranges 3.2 to 3.5 along the adjusted characteristic line 3.1. Herein, FIG. 3 clarifies the core of the invention, which is, that in the case that the gird voltage drops, for example, into the voltage range 3.3, not the time period, which corresponds to the accurate residual voltage value, but the time t3.3, which corresponds to the highest value of the voltage range 3.3, is given for the operation of the wind turbine in a manner deviating from the regular operation. That is, for example, in the case of a voltage drop to the residual voltage 3.7, it is defined by the characteristic line 3.1 (or characteristic line 2.1 in FIG. 2), that the wind turbine should be connected with the grid only at the time t3.7 and operated in an operation mode with reduced power within this time. According to the present invention, it is set herein, the concrete time t3.7 is not maintained in the case of a voltage drop to the residual voltage 3.7, but the wind turbine keeps connected to the grid with a time period t3.3, because the residual voltage 3.7 locates within the voltage range 3.3. The advantage of the approach is that, concrete factors can be attributed to each of the voltage ranges 3.2 to 3.5 for adjusting the wind turbine to realize the LVRT-operation mode, wherein these factors can be called from memories within the shortest time and can be used for controlling the wind turbine. Herein, the factors attributed to the voltage ranges can also be stored attributed to the second factors previously attributed to wind speed ranges, or can be determined in a simpler manner with these second factors, so as to achieve the suitable control parameters for the wind turbine within the shortest time. The first and second factors attributed to each voltage range and/or wind speed range can be used herein to control the blade angle of the rotor blade, to adjust the revolution number according to the current wind speed and thus to adjust the aerodynamic power and/or to trigger a resistance unit and/or to influence the effective power of the wind turbine if necessary.

The respective factors attributed to the voltage ranges 3.2 to 3.5 can be stored in the tables. In other tables, shut off period for the apparatuses, which must be shut off during the voltage dip, will be registered for each voltage range. The number of the step adjusts itself according to the current grid guide line, according to the computational device of the arrangement and according to the technical assemblies and according to the arrangement performance. In general, more fine stepped the range formation along the characteristic line is, more accurate the adjustment value of the wind turbine can be realized. Concerning the residual voltage and the dwell time defined by the residual voltage, the advantage of the steps or range formation are that control values are essentially provided without time delay and with any accuracy. Therefore, the relative long shut off time in the conventional manner in the case of the shut off of the wind turbine can be essentially shortened by approximate ¼ second. In the case of the further change of the voltage in the already available deviation of the grid voltage, it can react by switching to other table values.

The effectiveness of some table regulations goes beyond the grid error period based on the step formation described in FIG. 3.

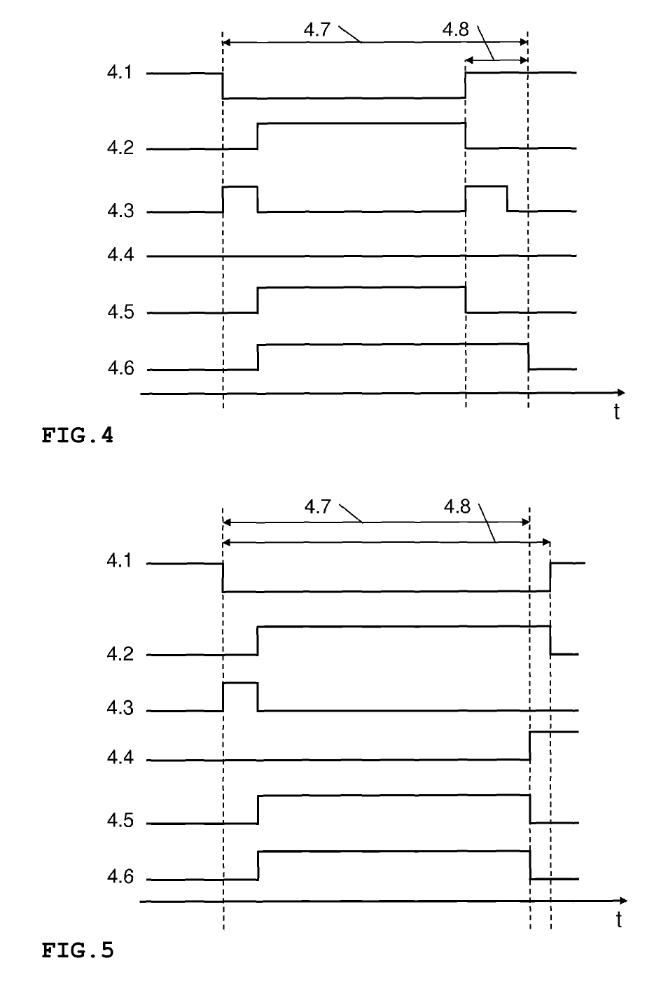

In FIG. 4 and FIG. 5, the signal states of measuring apparatuses and the control signal states realized from the signal states are described. Firstly, FIG. 4 will be described. In FIG. 4, the gird voltage curve 4.1, a measured grid voltage dip 4.2, the signal about the existence of an electric error, for example, a too high or too low current flow 4.3, the shut off curve 4.4, the operation with LVRT-operation 4.5 and the error suppression 4.6 are described over the time t. In the case of the grid voltage dip 4.1, a grid error or an electric error 4.3 can be registered. This signal of the occurring electric error 4.3 is correlated with the measured grid voltage dip 4.2. The detection of the electric error 4.3 causes the start of the state of the LVRT-operation 4.5. This means, that since this time point, the wind turbine will be operated in the operation that deviates from the regular operation manner, for example, with reduced power. Actually, in the case of the dip 4.1, the time of the deviating operation manner 4.7 given by the characteristic line starts. This time of the deviating operation manner 4.7 given by the characteristic line can be obtained from the characteristic line, as shown in FIG. 2. According to the present invention, not the concrete time period attributed to the respective voltage dip, but the time period attributed to the respective voltage range as described for FIG. 3 will be used to realize the deviating operation manner.

It is apparent, that the grid voltage 4.1 has taken the regular level again after a certain time 4.8. Hence, the signal about the measured grid voltage dip 4.2 ends. Hence, likewise, a new signal will be generated concerning an electric error 4.3. Therefore, by normalizing the grid voltage 4.1 within the time of the deviating operation manner 4.7 given by the characteristic line, the deviating operation manner, the LVRT-operation, 4.5 will be likewise ended, such that the wind turbine will be further operated in the regular operation again in the case of the normalization of the grid voltage. This means, that the shut off of the wind turbine does not need to be realized in the situation described in FIG. 4, because the grid voltage recovers within the time of the deviating operation manner 4.7 given by the characteristic line.

On the contrary, the situation is described in FIG. 5, in which the duration 4.8 of the deviation of the grid voltage 4.1 exceeds the time of the deviating operation manner 4.7 given by the characteristic line. The signal state curves in FIG. 5 are herein marked with the same references as in FIG. 4. A drop in the grid voltage 4.1 also occurs in the situation described in FIG. 5. This triggers the signal about an electric error 4.3, and the signal for the measured grid voltage dip 4.2 as already described with respect to FIG. 4. It is apparent, that the grid voltage 4.1 will be normalized only after the time of the deviating operation manner 4.7 given by the characteristic line is expired. In case of expiring the time of the deviating operation manner 4.7 given by the characteristic line, the signal for the shut off 4.4 will automatically be given. It is apparent, that the realized time of the deviating operation manner 4.8 is longer than the time of the deviating operation manner 4.7 given by the characteristic line. This is based on the step formation described in FIG. 3 and the time value derived from the step formation for each voltage range. Therefore, although a longer operation period of the wind turbine is realized than prescribed by respective lawmakers when grid errors occur, it has the advantage, that the data necessary for controlling the wind turbine can be essentially more rapidly and more reliably generated through the step formation along the characteristic line described in FIG. 3, than it would be in a computation for each concrete residual voltage value.

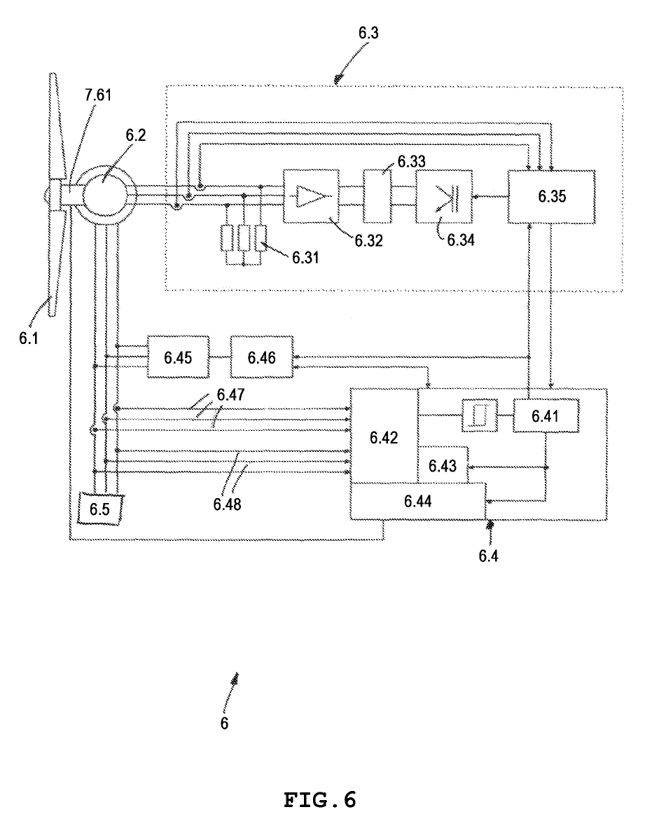

In the following, with respect to FIG. 6, a constructive configuration of a possible embodiment of a wind turbine 6, which can be used to implement the method according to the present invention, is shown. This wind turbine includes rotor blades 6.1 that are coupled to a generator 6.2. The generator 6.2 is signal technically coupled with an energy control device 6.3. In turn, the energy control device 6.3 is connected with suitable signal transmission devices with a control system 6.4. The wind turbine is connected to the grid 6.5, so as to be supplied with energy, for example, in the case of the calm winds or in the shut off state.

The energy control device 6.3 includes one or more resistances 6.31, which are connected through a switch 6.34 (e.g. IGBT), wherein a rectifier 6.32 and an overvoltage protection 6.33 can be preferably configured between one or more resistances 6.31 and the switch 6.34. This IGBT-switch 6.34 is coupled with a first control unit 6.35. The first control unit 6.35 is likewise coupled with the control system 6.4, which has a so-called LVRT-controller 6.41, to which a grid voltage measuring device 6.42, and a protection device 6.43 and a blade angle device 6.43 is connected. A second control unit 6.46 is likewise coupled with the first control unit 6.35 and the control system 6.4, the second control unit 6.46 can influence an idle power element 6.45. The generator 6.2 is connected with the control system 6.4 through current cables 6.47 and voltage cables 6.48.

When a deviation of a grid voltage or a grid error occurs, the blade angle of the rotor blades 6.1 is changed through the first control unit 6.35 to realize the operation of the wind turbine in the operation manner which deviates from the regular operation mode, so as to realize the desired revolution number. Furthermore, the first control unit 6.35 can so trigger the IGBT-switch 6.34, that through this a change of the current feed of the resistance 6.31 will be implemented, so that the electric energy generated from the wind turbine is transformed to heat energy there and thus influences the effective power generated from the wind turbine. Alternatively, the control system 6.4 can also be used for changing of the blade angle of the rotor blades 6.1.

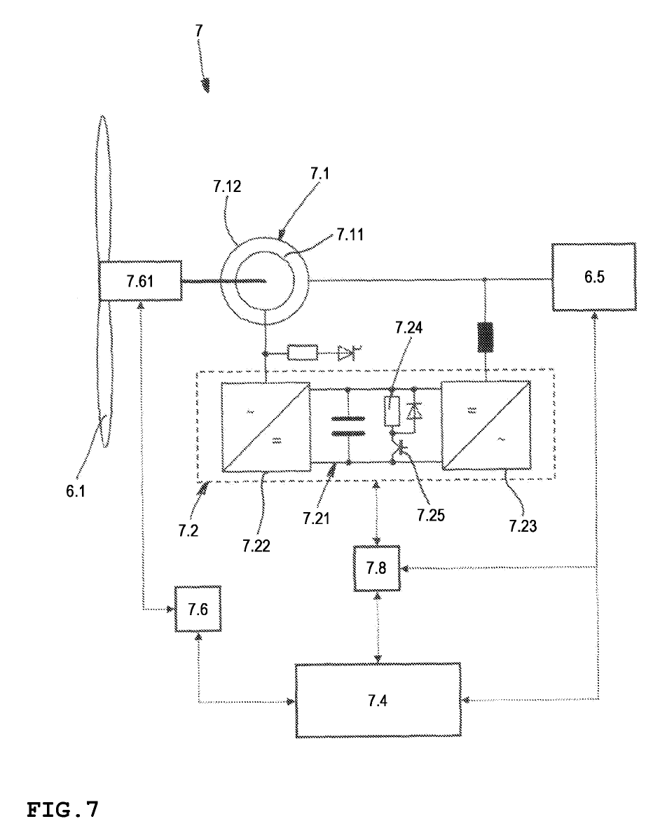

FIG. 7 describes another embodiment of a wind turbine 7, which can be used to implement the method described above. Herein, a double fed asynchronous generator 7.1 is used, the rotor 7.11 of which can be electrically connected with the grid 6.5 through a convert system 7.2 including a direct current voltage intermediate circuit 7.21 and two converters 7.22, 7.23. The stator 7.12 is directly connected with the grid 6.5 as described in the abovementioned embodiments. A resistance 7.24 together with a switch 7.25 is configured in the intermediate circuit 7.21 of the convert system 7.2.

A revolution number controller and regulator 7.6 for controlling the blade angle adjustment system 7.61 and an inverter controller 7.8 for controlling the convert system 7.2, which are in turn connected with the control system 7.4 of the wind turbine, are set. The control system 7.4 measures the grid voltage.

The elements of the control system 7.4 not described in FIG. 7 are partly involved in the previous embodiment. In the following, examples for stored adjustment values arranged in the form of tables and attributed to the voltage ranges are given:

TABLE 1
Examples for the error suppression period obtained from the given
characteristic line;

| Range | Voltage [%] | Time period (max.) | Time period (perferably) |
|---|---|---|---|
| 1 | >90% | 0 (kein LVRT) | |
| 2 | 90-45% | 2.5 s | 2.3 s |
| 3 | 45-22% | 1.75 s | |
| 4 | 22-0% | 1.12 s | |

TABLE 2
Examples for the effectiveness period of the following tables obtained from the
desired error suppression performance for each voltage drop;

| Range | Voltage [%] | Time period (max.) |
|---|---|---|
| 1 | >90% | 0 (no LVRT) |
| 2 | 90-45% | 2.5 s |
| 3 | 45-22% | 2.5 s |
| 4 | 22-0% | 2.5 s |

TABLE 3
Examples for the revolution number desired value of the generator in rotation
per minute, wherein the first number describes the revolution number for a grid
frequency of 50 Hz, and the second number describes the revolution number for a grid
frequency of 60 Hz, according to into which land or into which grid it should be provided;

| | Voltage | Wind range 1 | Wind range 2 | Wind range 3 | Wind range 4 |
|---|---|---|---|---|---|
| Range | [%] | 4-7 m/s | 8-11 m/s | 12-14 m/s | >14 m/s |
| 1 | >90% | 1560/1872 | 1560/1872 | 1560/1872 | 1560/1872 |
| 2 | 90-45% | 1590/1908 | 1590/1908 | 1590/1908 | 1590/1908 |
| 3 | 45-22% | 1590/1908 | 1590/1908 | 1650/1980 | 1650/1980 |
| 4 | 22-0% | 1590/1908 | 1650/1980 | 1650/1980 | 1650/1980 |

TABLE 4
Examples for the revolution number desired value of the generator in percent
concerning the nominal revolution number;

| | Voltage | Wind range 1 | Wind range 2 | Wind range 3 | Wind range 4 |
|---|---|---|---|---|---|
| Range | [%] | 4-7 m/s | 8-11 m/s | 12-14 m/s | >14 m/s |
| 1 | >90% | 100% | 100% | 100% | 100% |
| 2 | 90-45% | 102% | 102% | 102% | 102% |
| 3 | 45-22% | 102% | 102% | 106% | 106% |
| 4 | 22-0% | 102% | 106% | 106% | 106% |

TABLE 5
A first, preferable example for blade angel (Pitch)-offset values (in grad);

| | Voltage | Wind range 1 | Wind range 2 | Wind range 3 | Wind range 4 |
|---|---|---|---|---|---|
| Range | [%] | 4-7 m/s | 8-11 m/s | 12-14 m/s | >14 m/s |
| 1 | >90% | 0 | 0 | 0 | 0 |
| 2 | 90-45% | 0 | 0 | 0 | 0 |
| 3 | 45-22% | 0 | 0 | 0 | 2 |
| 4 | 22-0% | 0 | 0 | 2 | 2 |

TABLE 6
A second example for blade angel (Pitch)-offset values (in grad);

| | Voltage | Wind range 1 | Wind range 2 | Wind range 3 | Wind range 4 |
|---|---|---|---|---|---|
| Range | [%] | 4-7 m/s | 8-11 m/s | 12-14 m/s | >14 m/s |
| 1 | >90% | 0 | 0 | 0 | 0 |
| 2 | 90-45% | 0 | 0 | 0 | 0 |
| 3 | 45-22% | 0 | 0 | 3 | 0 |
| 4 | 22-0% | 0 | 0 | 3 | 0 |

TABLE 7
Examples for possible, advantageous duty cycle, that is, for controlling
the IGBT, wherein general guide values (left) and specially advantageous
value (right) are given in every column of a wind range.

| | Voltage | Wind range 1 | | Wind range 2 | | Wind range 3 | | Wind range 4 | |
|---|---|---|---|---|---|---|---|---|---|
| Range | [%] | 4-7 m/s | | 8-11 m/s | | 12-14 m/s | | >14 m/s | |
| 1 | >90% | 1 | 1 | 1 | 1 | 1 | 1 | 1 | 1 |
| 2 | 90-45% | 0.3 | 0.34 | 0.6 | 0.6 | 0.7 | 0.7 | 0.7 | 0.7 |
| 3 | 45-22% | 0.4 | 0.39 | 0.6 | 0.63 | 0.8 | 0.76 | 0.8 | 0.76 |
| 4 | 22-0% | 0.4 | 0.39 | 0.6 | 0.63 | 0.8 | 0.75 | 0.8 | 0.075 |

The feature combinations disclosed in the described embodiments do not limit the scope of the invention, and the features of different embodiments can rather be combined with each other.

### REFERENCE LIST

| | |
|---|---|
| 1.1 | grid error |
| 1.2 | error notification |
| 1.3 | trigger operation |
| 1.4 | reaction time |
| 1.5 | shut off delay |
| 1.6 | given characteristic line |
| 1.7 | adjusted characteristic line |
| 3.2 | first voltage range |
| 3.3 | second voltage range |
| 3.4 | third voltage range |
| 3.5 | fourth voltage range |
| 3.7 | residual voltage |
| 4.1 | grid voltage |
| 4.2 | measured voltage dip |
| 4.3 | grid error |
| 4.4 | shut off curve |
| 4.5 | state of the deviating operation |
| | manner |
| 4.6 | error suppression |
| 4.7 | time of the deviating operation |
| | manner given by characteristic line |
| 4.8 | realized time of the deviating |
| | operation manner |
| 6 | wind turbine |
| 6.1 | rotor blade |
| 6.2 | generator |
| 6.3 | energy control device |
| 6.31 | resistance |
| 6.32 | rectifier |
| 6.33 | overvoltage protection |
| 6.34 | switch |
| 6.35 | first control unit |
| 6.4 | control system |
| 6.41 | LVRT-control |
| 6.42 | grid voltage measuring device |
| 6.43 | protection device |
| 6.44 | blade angle control device |
| 6.45 | idle power element |
| 6.46 | second control unit |
| 6.47 | current cable |
| 6.48 | voltage cable |
| 6.5 | grid |
| 7 | wind turbine |
| 7.1 | asynchronous generator |
| 7.11 | rotor |
| 7.12 | stator |
| 7.2 | rectifier system |
| 7.21 | direct current voltage |
| | intermediate circuit |
| 7.22 | converter |
| 7.23 | converter |
| 7.24 | resistance |
| 7.25 | switch |
| 7.4 | control system |
| 7.6 | revolution number controller |
| | and regulator |
| 7.61 | blade angle adjustment system |
| 7.8 | inverter controller |

1. A method for operating a wind turbine (6; 7) connected to a power grid (6.5) for generating electric energy when a change in the grid voltage occurs, comprising
measuring the current residual grid voltage (3.7) when a deviation of a grid voltage from a certain regular grid voltage range occurs,
measuring the current wind speed,
defining a certain time period starting with the detection of the change in the grid voltage, depending on the value of the residual grid voltage (3.7),
operating the wind turbine (6; 7) within the defined time period, depending on the value of the residual grid voltage (3.7), in a certain operation mode that deviates from a regular operation,
operating the wind turbine (6; 7) again in the regular operation mode after the grid voltage (4.1) has been normalized within the defined time period, or shutting off the wind turbine (6; 7) at the end of the time period if the deviation of the grid voltage persists during the defined time period,
wherein,
voltage ranges (3.2, 3.3, 3.4, 3.5) are defined for grid voltage values that are not included in the regular grid voltage range,
wherein a plurality of voltage values and at least one first factor for controlling the wind turbine (6; 7), which is especially different for each voltage range (3.2, 3.3, 3.4, 3.5), are attributed to each defined voltage range (3.2, 3.3, 3.4, 3.5), so as to realize the operation mode deviating from the regular operation mode,
and depending on the measured wind speed, one of the first factors for controlling the wind turbine (6; 7) is used to realize the deviating operation mode.

2. The method according to claim 1, wherein the wind speed ranges are defined, wherein a plurality of wind speeds are attributed to each defined wind speed range and at least one second factor for controlling the wind turbine (6; 7) is attributed to each wind speed range so as to realize the operation that deviates from the regular operation.

3. The method according to claim 2, wherein a control desired value for the operation of the wind turbine (6; 7) is generated from the combination of the first and second factors so as to adjust the operation mode that deviates from the regular operation.

4. The method according to claim 1, wherein the first and/or the second factor and/or the control desired value is used to adjust the blade angle of the rotor blade (6.1) of the wind turbine (6; 7).

5. The method according to claim 4, wherein the value of the current blade angle upon a change in the grid voltage is obtained or called and an offset angle value is determined from the first and/or the second factor and/or the control desired value, or such an offset angle value, which is previously stored in a memory for a respective voltage range (3.2, 3.3, 3.4, 3.5) not included in the regular grid voltage range, is called from the memory, and will be fed to a controller of the wind turbine (6; 7) for the purpose of intrusion on the current blade angle, and the blade angle is correspondingly changed.

6. The method according to claim 1, wherein the first factor and/or the control desired value is used to regulate the operation of a resistance unit (6.31, 6.33, 6.34; 7.24, 7.25).

7. The method according to claim 1, wherein the defined time period is defined according to the highest voltage value of a defined grid voltage range.

8. The method according to claim 1, wherein a respective first and/or second factor and/or control desired value attributed to the respective voltage range and/or wind range is defined and stored in at least one memory and is called therefrom when the deviation of the voltage corresponding to the respective factor and/or control desired value occurs.

9. The method according to claim 1, wherein at least one of the factors and/or the control desired value is used for the selection and trigger of wind turbine apparatuses, which are shut off during the time of the deviation of the grid or operated in an operation mode which deviates from its regular operation mode.

10. The method according to claim 1, wherein at least one of the factors and/or the control desired value is used to control the idle power of the wind turbine (6; 7) during the deviation of the grid.

11. The method according to claim 1, wherein when a new change of the grid voltage to a voltage value, which is not included in the voltage range corresponding to the initial deviation of the voltage, occurs within the defined time period, another first factor for controlling the wind turbine (6; 7) will be used to realize the operation mode which deviates from the regular operation mode.

12. A wind turbine (6; 7), which is connectable or connected to a power grid (6.5) to supply electric current, comprising:
at least one gird voltage measuring device (6.45),
at least one wind speed measuring device,
at least one control device (6.4; 7.4, 7.6, 7.8), set to realize a plurality of operation modes which deviate from the regular operation,
at least one first memory, in which first factors attributed to different grid voltage ranges are storable or stored.

13. The wind turbine (6; 7) according to claim 12, wherein the wind turbine (6; 7) includes at least one computation unit, by means of which an offset-angle value is able to be calculated from the first and/or the second factor and/or the control desired value.

14. The wind turbine (6; 7) according to claim 12, wherein the wind turbine (6; 7) comprises at least one resistance unit (6.31. 6.33, 6.34; 7.24, 7.25), by means of which the electric energy generated from the wind turbine (6; 7) is transformable to heat energy for the purpose of the regulation of the power of the wind turbine (6; 7).

15. The wind turbine (6; 7) according to claim 12, wherein the wind turbine (6; 7) comprises at least one compensation arrangement (6.42; 7.2), by means of which the idle power of the wind turbine (6; 7) is adjustable
